(19) United States
(12) Patent Application Publication
(10) Pub. No.: US 2004/0262819 A1
(43) Pub. Date: Dec. 30, 2004

(54) Method for forming patterns on shoe sole

(76) Inventor: Kuo Chan Lee, Taichung (TW)

Correspondence Address: Kuo Chan Lee, P.O. Box 63-99, Taichung, 406, TW

(21) Appl. No.: 10/608,394

(22) Filed: Jun. 24, 2003

(51) Int. Cl. B29C 51/00

(52) U.S. Cl. 264/553; 264/259

(57) ABSTRACT

A method for forming a pattern on a shoe sole includes a film having one or more recesses shaped or formed by such as a heating or vacuuming process, or to form the film into a shape corresponding to the shoe sole to be manufactured. A material is then filled or mold injected into the recess of the film, to have the material and the film secured together and to form the shoe sole. The film may include one or more patterns applied on one or more surfaces for allowing the patterns to be easily and quickly formed onto the shoe sole together with the film.

### BACKGROUND OF THE INVENTION

1. Field of the Invention

The present invention relates to a manufacturing method, and more particularly to a manufacturing method or process for forming patterns on shoe soles.

2. Description of the Prior Art

Various kinds of typical manufacturing methods or processes have been developed and provided for forming patterns on shoe soles.

For example, U.S. Pat. No. 4,841,648 to Shaffer et al., and U.S. Pat. No. 5,331,753 to Rodibaugh disclose two of the typical methods or processes for forming patterns on shoe soless, and comprise blocks or panels to be formed separately and attached or secured onto the shoe sole with hot-pressing processes or by adhesive materials, or the like.

However, it is time consuming, and a lot of molding processes are required for forming or manufacturing the blocks or panels separately, and the blocks or panels are then required to be attached or secured onto the shoe sole, such that the manufacturing procedures or processes are complicated.

U.S. Pat. No. 5,586,354 to Chi discloses the other typical method or process for forming patterns on shoe soless, and comprises a film having various patterns applied thereon, and to be transferred onto the shoe sole. However, the patterns, sometimes, may not be completely transferred onto the shoe sole, such that the patterns may not be completely formed on the shoe soles.

In addition, the patterns that are transferred or formed or applied onto the shoe soles may be exposed after the film is removed from the shoe sole, and thus may be easily worn out after use.

The present invention has arisen to mitigate and/or obviate the afore-described disadvantages of the conventional methods or processes for forming patterns on shoe soles.

### SUMMARY OF THE INVENTION

The primary objective of the present invention is to provide a method for allowing patterns to be firmly or solidly formed or attached or applied onto the shoe soles, and for preventing the patterns from being easily removed or disengaged or worn out from the shoe soles.

In accordance with one aspect of the invention, there is provided a method for forming a pattern on a shoe sole, the method comprising providing a film, shaping one or more recesses in the film to have a shape corresponding to that of the shoe sole to be manufactured, and molding a material into the recess of the film, to have the material and the film secured together and to form the shoe sole. The film may be solidly secured to the material or the material and the film may be formed integral with each other to easily and quickly form the shoe sole. The patterns may thus be firmly or solidly formed or attached or applied onto the shoe soles, and may be prevented from being easily removed or disengaged or worn out from the shoe soles.

The film may include one or more patterns provided or applied or formed or printed or painted thereon for allowing the patterns to be easily and quickly formed on the shoe sole. The pattern is preferably arranged or formed between the film and the material, for allowing the pattern to be solidly formed or retained between the film and the material.

The film is preferably heated and/or vacuumed before shaping the recess in the film. For example, a mold device may be provided and may include a heating member provided therein to heat and to soften the film and to conform the film with a mold cavity of the mold piece, and thus to shape the recess in the film.

A cover may further be provided and attached onto the mold device to form a mold chamber between the mold device and the cover. The mold device may include one or more orifices formed or provided therein for vacuuming the mold device.

The mold device may include a mold piece having a mold cavity formed therein to receive the shaped film and to mold and form the shoe sole. The mold piece may include one or more swellings provided or formed therein and extended into the mold cavity of the mold piece, to form one or more bulges in the film, and to form one or more depression in the shoe sole.

The mold piece may include one or more orifices formed therein and communicating with the mold cavity of the mold piece, to form one or more recesses in the film, and to form one or more projections on the shoe sole. An upper mold piece may further be provided and attached onto the mold piece to retain the film between the mold pieces.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a block diagram illustrating processes of a method for forming patterns on shoe soles in accordance with the present invention;

FIG. 2 is a partial exploded view illustrating a mold device for conducting the processes of the method for forming patterns on shoe soles;

FIG. 3 is a cross sectional view illustrating the mold device as shown in FIG. 2;

FIG. 4 is a partial exploded view illustrating the mold device for conducting the processes of the method for forming patterns on shoe soles;

FIG. 5 is a partial cross sectional view illustrating the molding procedures of the method for forming patterns on shoe soles; and

FIG. 6 is a perspective view of a shoe sole to be manufactured or formed with the method for forming patterns on shoe soles in accordance with the present invention.

### DETAILED DESCRIPTION OF THE PREFERRED EMBODIMENT

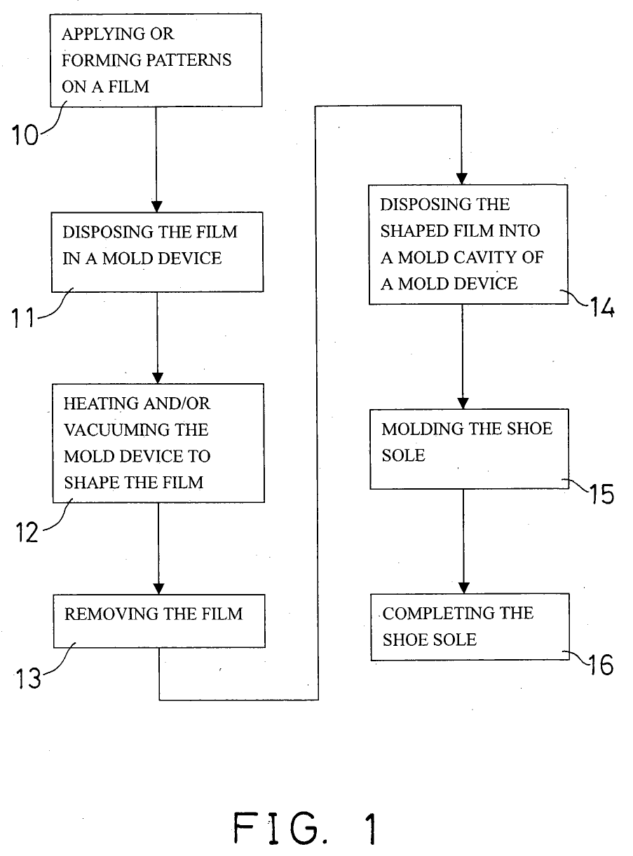

Referring to the drawings, and initially to FIG. 1, a method in accordance with the present invention is provided for forming patterns on shoe soles, and comprises several processes or procedures 10-16 for manufacturing or forming the patterns onto the shoe soles 70 (FIG. 6).

For example, one or more patterns 22 are formed or applied or painted or typed or printed onto a film 20 in the process 10, and preferably having shapes or contours similar to the shapes of the shoe soles 70 to be formed or manufactured. The film 20 is preferably made of polyurethane (PU) materials or the other synthetic materials.

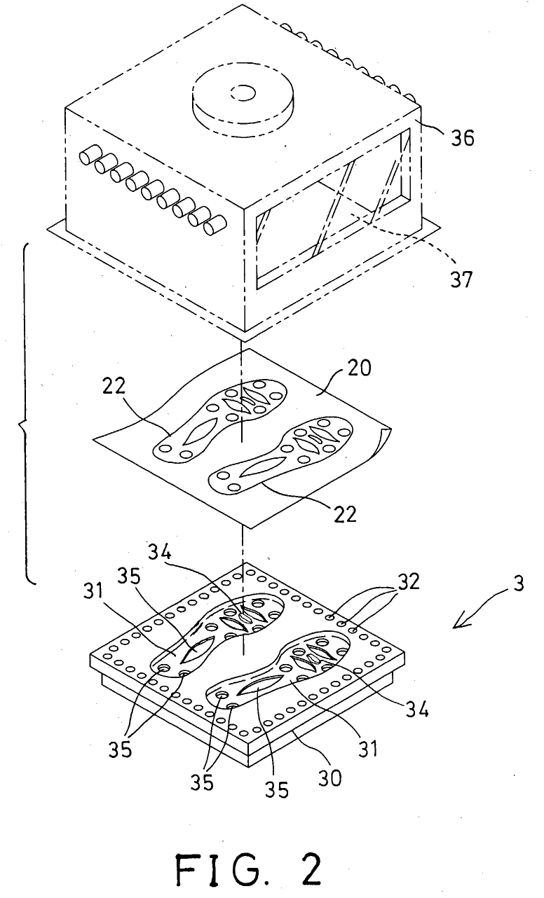

As shown in FIG. 2, illustrated is a mold device 3 for forming or shaping the film 20. For example, the mold device 3 includes a mold piece 30 having one or more mold cavities 31 formed therein that include the shapes similar to or corresponding to the shoe soles 70 to be formed or manufactured. The film 20 is to be disposed or supported on top of the mold piece 30 of the mold device 3 in process 11 (FIG. 1).

The mold piece 30 may further include one or more swellings 34 extended into the mold cavity 31 thereof, for forming corresponding bulges 23 in the film 20 and corresponding depressions 71 in the shoe sole 70; and/or one or more orifices 35 formed therein and communicating with the mold cavity 31 thereof, for forming corresponding recesses 24 in the film 20 and corresponding projections 73 on the shoe sole 70.

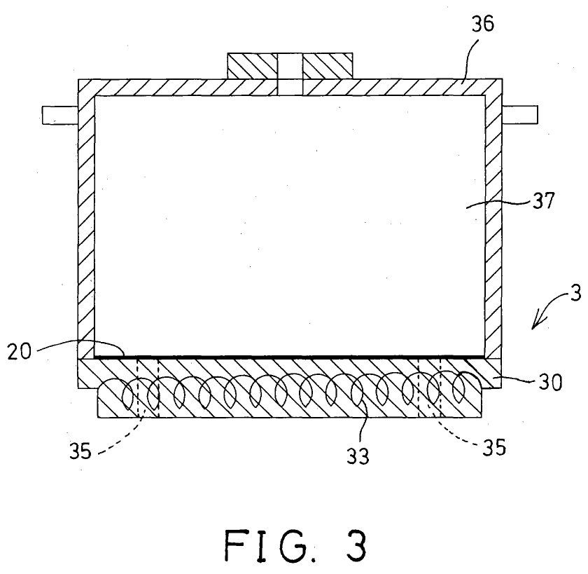

The mold piece 30 may include one or more passages 32 formed therein, to receive hot water (not shown) or the like for heating and/or softening the film 20. As shown in FIG. 3, the mold piece 30 may further or alternatively include a heating device 33 disposed therein for heating and/or softening the film 20, and for allowing the film 20 to be engaged or conformed onto or into the swellings 34 or the orifices 35 of the mold piece 30.

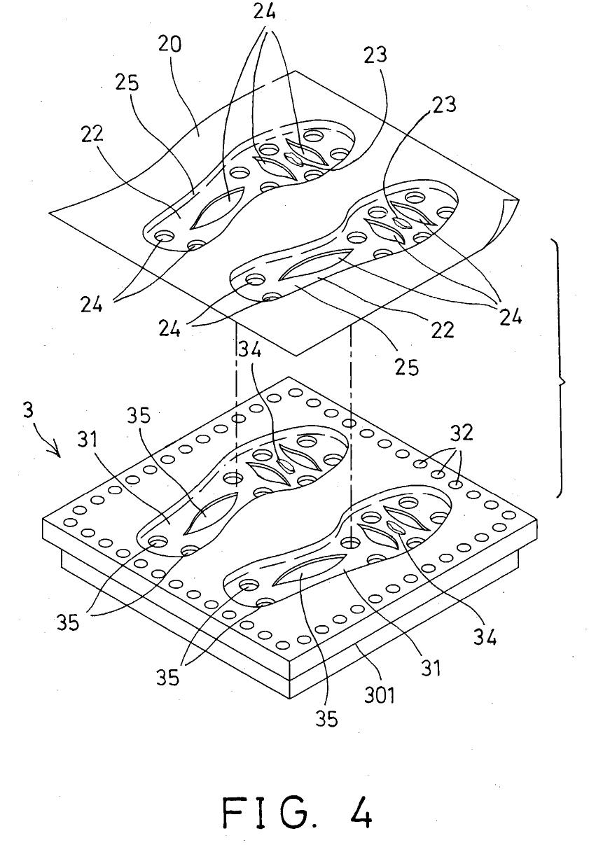

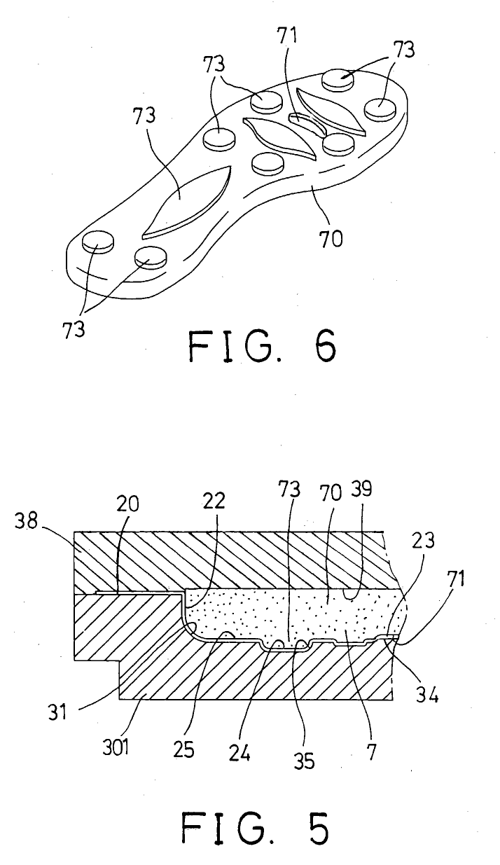

The mold piece 30 may be vacuumed by a vacuum device (not shown) through the orifices 35 of the mold piece 30, in order to force the film 20 to engage or conform onto or into the swellings 34 or the orifices 35 of the mold piece 30, and so as to form the bulges 23 and the recesses 24 in the film 20 (FIGS. 4, 5). The film 20 may also be heated and/or vacuumed to form one or more recesses 25 therein corresponding to the mold cavities 31 of the mold piece 30, and corresponding to the outer shapes or contours of the shoe sole 70 to be formed or manufactured.

The film 20 may thus be shaped into the required shape by a heating and vacuuming process 12 (FIG. 1). As shown in FIGS. 2 and 3, a cover 36 may further be provided and engaged onto the mold piece 30, for forming an enclosed chamber 37 therein, or for forming the enclosed chamber 37 between the mold piece 30 and the cover 36, and/or for allowing the film 20 to be suitably shaped into the required shape by the heating and vacuuming process 12.

After the film 20 has been suitably shaped into the required shape, the film 20 may be removed from the mold piece 30 in a process 13 as shown in FIG. 1, and may then be disposed in a mold cavity 31 of another mold piece 301 that also includes a shape corresponding to the outer shapes or contours of the shoe sole 70 to be formed or manufactured, in a process 14 as shown in FIG. 1.

Alternatively, without being removed from the mold piece 30, the film 20 may also be maintained or retained in the mold cavity 31 of the mold piece 30. As shown in FIG. 5, another or an upper mold piece 38 may further be provided and engaged onto either the lower mold piece 30 or 301, to retain the film 20 between the mold pieces 30 or 301 and 38, and/or to form a mold chamber 39 in or between the mold pieces 30 or 301 and 38 that includes a shape corresponding to the outer shapes or contours of the shoe sole 70 to be formed or manufactured.

A material 7 for forming or manufacturing the shoe sole 70 is then injected or filled into the mold chamber 38 of the mold pieces 30 or 301 and 38, in order to mold or mold inject the shoe sole 70 in process 15 of FIG. 1. The film 20 may be solidly secured or attached onto the material 7 while forming or manufacturing or molding the shoe sole 70, in such as a hot-pressing process or the like, in order to form the product of the shoe sole 70 as shown in FIG. 6, in process 16 of FIG. 1.

After the molding or mold injecting process 15 of the shoe sole 70, the film 20 may probably have an outer peripheral portion extended out of the shoe sole 70, and may be required to be cut or trimmed before the final or completed shoe sole 70 may be formed.

It is to be noted that the patterns 22 may be formed or applied onto the film 20, and the film 20 may be solidly secured or attached onto the shoe sole 70 without being removed from the shoe sole 70, such that the patterns 22 may also be solidly or firmly formed or applied onto the film 20 and the shoe sole 70. It is preferable, but not necessarily, that the patterns 22 are formed or applied or provided between the film 20 and the shoe sole 70.

Alternatively, the film 20 itself may include various patterns or colors provided thereon without additional printing or painting or typing processes, and may also be solidly attached or formed on the outer peripheral portion of the shoe sole 70 by a shaping process to form one or more recesses 25 in the film 20, and a mold injecting process to mold the material 7 into the recesses 25 of the film 20.

Accordingly, the method for forming patterns on shoe soles in accordance with the present invention may be used for allowing patterns to be firmly or solidly formed or attached or applied onto the shoe soles, and for preventing the patterns from being easily removed or disengaged or worn out from the shoe soles.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for forming a pattern on a shoe sole, said method comprising:
providing a film,
shaping at least one recess in said film to have a shape corresponding to that of the shoe sole to be manufactured, and
molding a material into said at least one recess of said film, to have said material and said film secured together and to form the shoe sole.

2. The method as claimed in claim 1 further comprising providing at least one pattern on said film.

3. The method as claimed in claim 2, wherein said at least one pattern is arranged between said film and said material.

4. The method as claimed in claim 1 further comprising heating said film before shaping said at least one recess in said film.

5. The method as claimed in claim 3 further comprising providing a mold device to heat said film and to shape said at least one recess in said film.

6. The method as claimed in claim 5 further comprising providing a heating member in said mold device to heat said film.

7. The method as claimed in claim 5 further comprising providing and attaching a cover onto said mold device to form a mold chamber between said mold device and said cover.

8. The method as claimed in claim 5 further comprising vacuuming said mold device to shape said film.

9. The method as claimed in claim 8 further comprising providing at least one orifice in said mold device to vacuum said mold device.

10. The method as claimed in claim 1 further comprising providing a mold piece to mold and form the shoe sole.

11. The method as claimed in claim 10 further comprising providing a mold cavity in said mold piece to receive said film, and to mold and form the shoe sole.

12. The method as claimed in claim 10 further comprising providing at least one swelling in said mold piece and extended into said mold cavity of said mold piece, to form at least one bulge in said film, and to form at least one depression in the shoe sole.

13. The method as claimed in claim 10 further comprising forming at least one orifice in said mold piece and communicating with said mold cavity of said mold piece, to form at least one recess in said film, and to form at least one projection on the shoe sole.

14. The method as claimed in claim 1 further comprising providing and attaching an upper mold piece onto said mold piece to retain said film between said upper mold piece and said mold piece.
